(19) United States
(12) Patent Application Publication
(10) Pub. No.: US 2012/0029943 A1
(43) Pub. Date: Feb. 2, 2012

(54) REPORT GENERATION MANAGEMENT DEVICE AND PROGRAM

(75) Inventor: Akira Kurahashi, Tokyo (JP)

(73) Assignee: KONICA MINOLTA MEDICAL & GRAPHIC, INC., Hino-shi, Tokyo (JP)

(21) Appl. No.: 13/260,331

(22) PCT Filed: Feb. 23, 2010
(86) PCT No.: PCT/JP2010/052671

§ 371 Date: Sep. 25, 2011

(30) Foreign Application Priority Data
Mar. 26, 2009 (JP) 2009-076440

(51) Int. Cl. G06Q 50/24

(52) U.S. Cl. 705/3

(57) ABSTRACT

A report generation management device includes a storage unit which stores interpretation report information, and a control unit. The control unit generates a plurality of pieces of interpretation report information for one examination, stores the generated pieces of the interpretation report information in the storage unit, and manages the generated pieces of the interpretation report information by correlating the generated pieces of the interpretation report information with the examination.

### FIELD OF THE INVENTION

The present invention relates to a report generation management device and a program therefor.

### BACKGROUND OF THE ART

At a medical facility such as a hospital or a clinic, a patient is photographed by using a medical image photographic device (modality) such as an X-ray device to generate a medical image (medical image data). A radiologist displays the generated medical image on a monitor, and generates an interpretation report on the medical image.

As a system to generate an interpretation report, for example, a medical image processing system is disclosed by Japanese Patent Application Laid-open Publication No. 2006-51198, the medical image processing system including an image quality inspection terminal into which an additional imaging determining section is incorporated. The additional imaging determining section performs a predetermined image analysis on image data generated by an image generation unit so as to objectively determine the necessity of additional imaging or the like and the type thereof.

Such a system generates one interpretation report for one examination. That is, interpretation reports and examinations have a one-to-one relationship.

### RELATED ART DOCUMENT

### Patent Document

Patent Document 1: Japanese Patent Application Laid-open Publication No. 2006-51198

### SUMMARY OF THE INVENTION

### The Problems to be Solved by the Invention

In a mammogram examination in which breasts of a patient are photographed with a breast photographic device which is a type of an X-ray device, medical images of right and left breasts are generated in one examination. In this case, it is necessary to generate an interpretation report on the right breast and an interpretation report on the left breast.

However, in a conventional system, one interpretation report is generated for one examination. Therefore, an interpretation report on the right breast and an interpretation report on the left breast are generated as one interpretation report. That is, the conventional system is not suitable for a case where a plurality of assessments (interpretation reports) is required for one examination.

For example, when a doctor would like to look at an interpretation report on a right breast, it is difficult for the doctor to directly search for the interpretation report on the right breast.

The present invention is made in view of the circumstances, and an object of the present invention is to provide a system for generating interpretation reports, the system which is suitable for a case where a plurality of interpretation reports is required for one examination.

### Means for Solving the Problems

To solve the problem mentioned above, the present invention disclosed by claim 1 is a report generation management device including: a storage unit which stores interpretation report information; and a control unit which generates a plurality of pieces of the interpretation report information for one examination, stores the generated pieces of the interpretation report information in the storage unit, and manages the generated pieces of the interpretation report information by correlating the generated pieces of the interpretation report information with the examination.

According to the present invention disclosed by claim 2, in the present invention disclosed by claim 1, the control unit generates each of the pieces of the interpretation report information on a medical image of a part of a subject in the examination.

According to the present invention disclosed by claim 3, in the present invention disclosed by claim 1, wherein the control unit generates each of the pieces of the interpretation report information on a medical image of a side of a subject in the examination.

According to the present invention disclosed by claim 4, in the present invention disclosed by claim 3, the examination is a mammogram examination, and the medical image of the side is a right breast image or a left breast image.

According to the present invention disclosed by claim 5, in the present invention disclosed by claim 1, the control unit generates each of the pieces of the interpretation report information on a series of a medical image in the examination.

According to the present invention disclosed by claim 6, in the present invention disclosed by any one of claims 1 to 5, the control unit generates overall interpretation report information for the examination based on the pieces of the interpretation report information.

The present invention disclosed by claim 7 is a program for making a computer execute functions of: a storage unit which stores interpretation report information; and a control unit which generates a plurality of the interpretation report information for one examination, stores the generated pieces of the interpretation report information in the storage unit, and manages the generated pieces of the interpretation report information by correlating the generated pieces of the interpretation report information with the examination.

### Advantageous Effects of the Invention

According to the present invention disclosed by claim 1 and claim 7, a control unit which generates a plurality of pieces of the interpretation report information for one examination, stores the generated pieces of the interpretation report information in the storage unit, and manages the generated pieces of the interpretation report information by correlating the generated pieces of the interpretation report information with the examination.

Accordingly, a system for generating interpretation reports can be provided, the system which is suitable for a case where a plurality of interpretation reports is required for one examination.

According to the present invention disclosed by claim 2, the control unit generates each of the pieces of the interpretation report information on a medical image of a part of a subject in the examination. Accordingly, the present invention is suitable for a case where a plurality of interpretation reports on parts of a subject is required for one examination.

According to the present invention disclosed by claim 3, the control unit generates each of the pieces of the interpretation report information on a medical image of a side of a subject in the examination. Accordingly, the present invention is suitable for a case where a plurality of interpretation reports on sides of a subject is required for one examination.

According to the present invention disclosed by claim 4, the present invention is suitable for a mammogram examination in which an interpretation report on a right breast and an interpretation report on a left breast are generated.

According to the present invention disclosed by claim 5, the control unit generates each of the pieces of the interpretation report information on a series of a medical image in the examination. Accordingly, the present invention is suitable for a case where a plurality of interpretation reports on a plurality of series of medical images is required for one examination.

According to the present invention disclosed by claim 6, the control unit generates overall interpretation report information for the examination based on the pieces of the interpretation report information. Accordingly, the convenience in a case where a plurality of interpretation reports on parts of a subject or the like is required for one examination can be increased.

### BRIEF DESCRIPTION OF THE DRAWINGS

FIG. 1 is a block diagram showing an example of a system configuration of a radiology system;

FIG. 2 is a block diagram showing a data configuration of a medical image data object;

FIG. 3 is a block diagram of an image viewer terminal;

FIG. 4 is a block diagram of a report generation management device;

FIG. 5 is an image view showing a relationship between interpretation reports and medical images in a mammogram examination;

FIG. 6 is a block diagram showing a data model of an interpretation report in a mammogram examination;

FIG. 7 is a block diagram showing a data configuration of an interpretation report data object;

FIG. 8 is a flowchart showing specific operations performed by the report generation management device and the image viewer terminal;

FIG. 9 is a flowchart showing a report generation process;

FIG. 10 shows an example of a report generation screen;

FIG. 11 shows another example of the report generation screen;

FIG. 12 is an image view showing a relationship between interpretation reports and medical images in a CT (Computed Tomography) examination;

FIG. 13 is a block diagram showing a data model of an interpretation report in a CT examination; and

FIG. 14 is a block diagram showing a data configuration of an interpretation report data object.

### BEST MODE FOR CARRYING OUT THE INVENTION

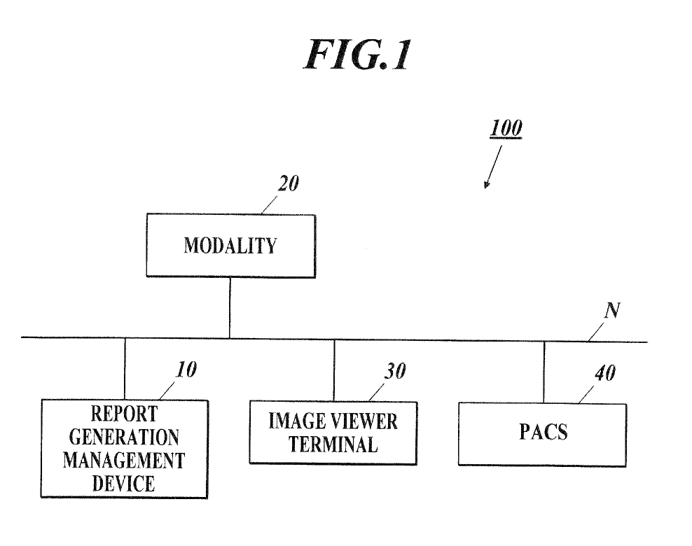

In the following, an embodiment in which a report generation management device of the present invention is applied to a report generation management device 10 shown in FIG. 1 is described referring to FIGS. 1 to 11.

### [System Configuration of Radiology System]

First, a radiology system 100 including the report generation management device 10 is described in summary referring to FIG. 1.

FIG. 1 is a block diagram showing an example of a system configuration of the radiology system 100. As shown in FIG. 1, the radiology system 100 includes the report generation management device 10, a modality 20, an image viewer terminal 30, and a PACS (Picture Archiving and Communication System) 40. The components are connected with each other via a communication network N such as a LAN (Local Area Network) so as to perform data communications.

The modality 20 is a medical photographic device by which a patient is photographed, thereby generating image data (actual image data) of a taken image (medical image). Various modalities by which medical images are taken can be applied to the modality 20. The various modalities are a CT device, a CR (Computed Radiography) device, an MRI (Magnetic Resonance Imaging) device, a breast photographic device, an ultrasound diagnostic device, and the like. In the embodiment, the description is made by taking a breast photographic device as the modality 20. In the following, an examination performed by the breast photographic device is referred to as a mammogram examination.

The modality 20 receives order information from a not-shown RIS (Radiation Information System). The RIS is a system which manages information in the radiology system 100 as a whole. The order information is data showing contents of an examination order for photography or a diagnosis.

The modality 20 generates supplementary information including various kinds of information (patient information, examination information, series information, and the like) on the actual image data of the generated medical image, based on the order information received from the RIS. Then, the modality 20 attaches the supplementary information to the actual image data, and generates medical image data complying with the DICOM (Digital Imaging and COmmunication in Medicine) standard. The modality 20 sends the generated medical image data to the PACS 40.

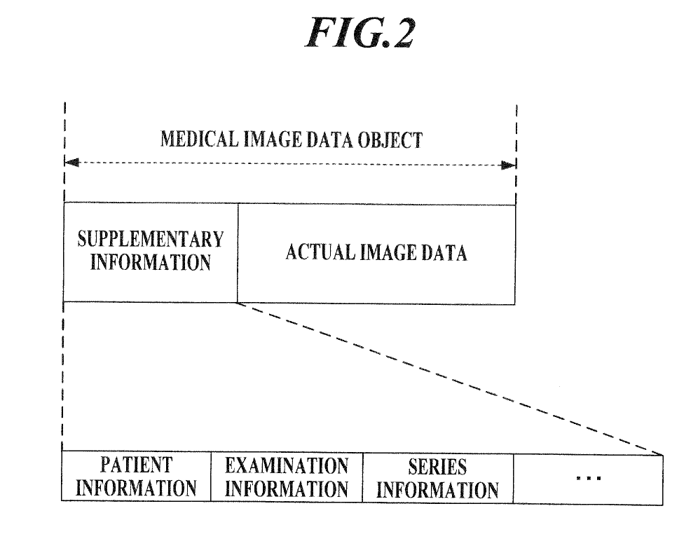

FIG. 2 shows a data configuration of medical image data for one medical image (a medical image data object, hereinbelow). As described above, a medical image data object is constituted of actual image data for one medical image and supplementary information on the actual image data. The supplementary information includes patient information, examination information, and series information.

As shown in FIG. 1, the PACS 40 is a database system which saves and manages the medical image data generated in the modality 20, and performs a search and a data analysis. The PACS 40 includes a control unit, a storage unit, and a communication unit, and accumulates and stores the medical image data in a relational database or the like based on the supplementary information included in the medical image data received from the modality 20. Then, the PACS 40 searches for medical image data by using a patient ID, an examination ID or the like as a search key which is specified in accordance with an operation command of a radiologist or the like, and outputs the medical image data to the image viewer terminal 30 or a not-shown imager. In addition, when receiving a medical image data obtaining request including a search key such as a patient ID or an examination ID from an external device, the PACS 40 searches for medical image data matching the obtaining request, and supplies (sends) the medical image data to the external device.

The image viewer terminal 30 has a viewer function to display medical image data, and serves a radiologist or the like when the radiologist or the like performs interpretation on the medical image data. The image viewer terminal 30 sends a medical image data obtaining request to the PACS 40, and obtains medical image data matching the obtaining request from the PACS 40. Then, the image viewer terminal 30 displays the obtained medical image data. In addition, the image viewer terminal 30 sends the obtained medical image data to the report generation management device 10.

The report generation management device 10 has a report generation function to generate an interpretation report on medical image data and a report management function to manage the generated interpretation report, and serves a radiologist or the like when the radiologist or the like creates an interpretation report on medical image data. The report generation management device 10 generates an attached-to-report image based on the medical image data received from the image viewer terminal 30, and displays a report generation screen. The report generation management device 10 generates an interpretation report (interpretation report data) based on an operation command of a radiologist or the like. The report generation management device 10 saves and manages the generated interpretation report.

### [Functional Configuration of Image Viewer Terminal]

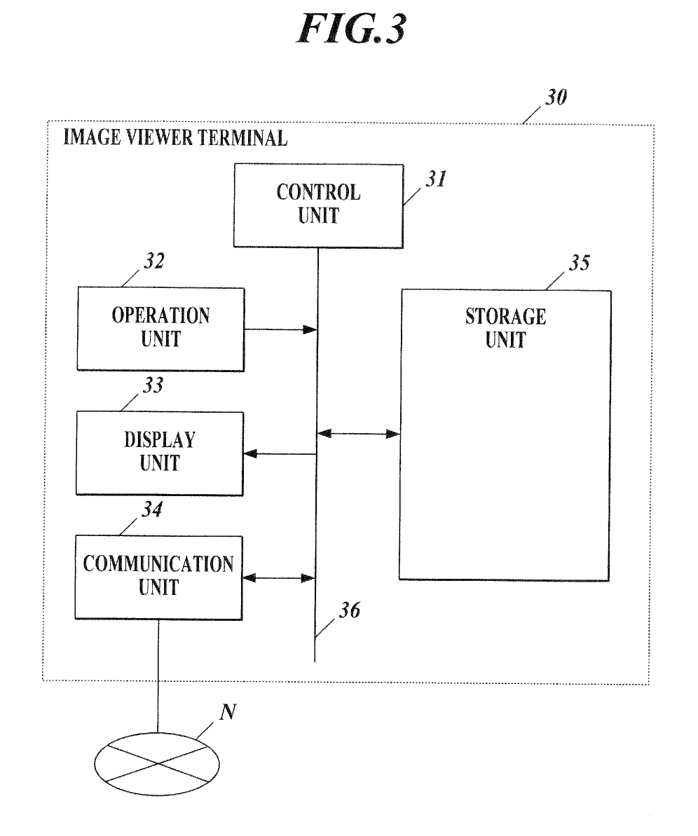

FIG. 3 shows a functional configuration of the image viewer terminal 30.

As shown in FIG. 3, the image viewer terminal 30 includes a control unit 31, an operation unit 32, a display unit 33, a communication unit 34, and a storage unit 35. The components are connected with each other by a bus 36.

The control unit 31 includes a CPU (Central Processing Unit) and a RAM (Random Access Memory), and controls process operations of the components of the image viewer terminals 30 as a whole. More specifically, the CPU reads a process program of various process programs stored in the storage unit 35 in accordance with an operation signal inputted from the operation unit 32 or a command signal received by the communication unit 34, expands the read program in a work area formed in the RAM, and performs a process by working in cooperation with the program.

The operation unit 32 is constituted of a keyboard including cursor keys, number input keys, and various function keys, and a pointing device such as a mouse. The operation unit 32 outputs an operation signal to the control unit 31, the operation signal which is inputted by a key operation onto the keyboard or a mouse operation.

The display unit 33 is constituted of a high definition LCD (Liquid Crystal Display), and displays various screens based on display data inputted from the control unit 31.

The communication unit 34 includes a LAN (Local Area Network) adaptor, a router, and a TA (Terminal Adapter), and sends/receives data to/from external devices such as the report generation management device 10 and the PACS 40 via the communication network N.

The storage unit 35 is constituted of a hard disk or the like, and stores a control program and parameters, files, and the like necessary for executing the program.

When receiving an image display command from the report generation management device 10 via the communication unit 34, the control unit 31 generates a medical image data obtaining request based on the image display command. Then, the control unit 31 sends the generated medical image data obtaining request to the PACS 40 via the communication unit 34.

When obtaining medical image data matching the medical image data obtaining request from the PACS 40 via the communication unit 34, the control unit 31 transfers the medical image data to the report generation management device 10. In addition, the control unit 31 displays, on the display unit 33, a medical image and supplementary information thereon based on the obtained medical image data.

### [Functional Configuration of Report Generation Management Device]

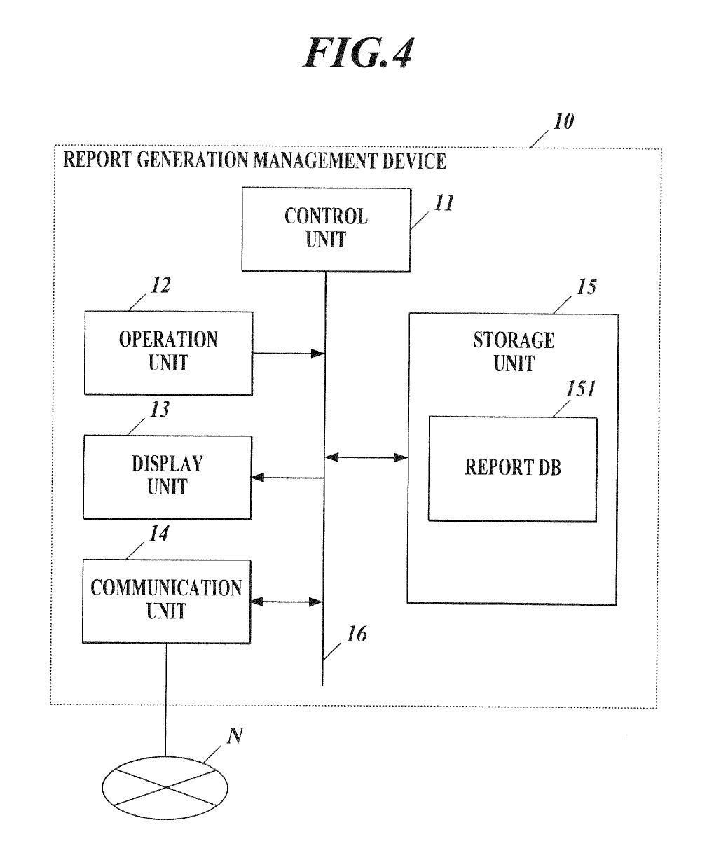

FIG. 4 shows a functional configuration of the report generation management device 10.

As shown in FIG. 4, the report generation management device 10 includes a control unit 11, an operation unit 12, a display unit 13, a communication unit 14, and a storage unit 15. The components are connected with each other by a bus 16.

The control unit 11 includes a CPU and a RAM, and controls process operations of the components of the report generation management device 10 as a whole. More specifically, the CPU reads a process program of various process programs stored in the storage unit 15 in accordance with an operation signal inputted from the operation unit 12 or a command signal received by the communication unit 14, expands the read program in a work area formed in the RAM, and performs a process by working in cooperation with the program.

The operation unit 12 is constituted of a keyboard including cursor keys, number input keys, and various function keys, and a pointing device such as a mouse. The operation unit 12 outputs an operation signal to the control unit 11, the operation signal which is inputted by a key operation onto the keyboard or a mouse operation.

The display unit 13 is constituted of an LCD, and displays various screens based on display data inputted from the control unit 11.

The communication unit 14 includes a LAN adaptor, a router, and a TA, and sends/receives data to/from an external device such as the image viewer terminal 30 via the communication network N.

The storage unit 15 is constituted of a hard disk or the like, and stores a control program and parameters, files, and the like necessary for executing the program. The storage unit 15 stores a report DB (DataBase) 151. The report DB 151 is a database to store and manage interpretation report data.

When obtaining medical image data from the image viewer terminal 30 via the communication unit 14, the control unit 11 generates an attached-to-report image based on the medical image data. The control unit 11 generates a report generation screen to which the attached-to-report image is attached, and displays the report generation screen on the display unit 13. Then, the control unit 11 performs a report generation process so as to generate interpretation report data. The control unit 11 stores and manages the generated interpretation report data in the report DB 151 of the storage unit 15.

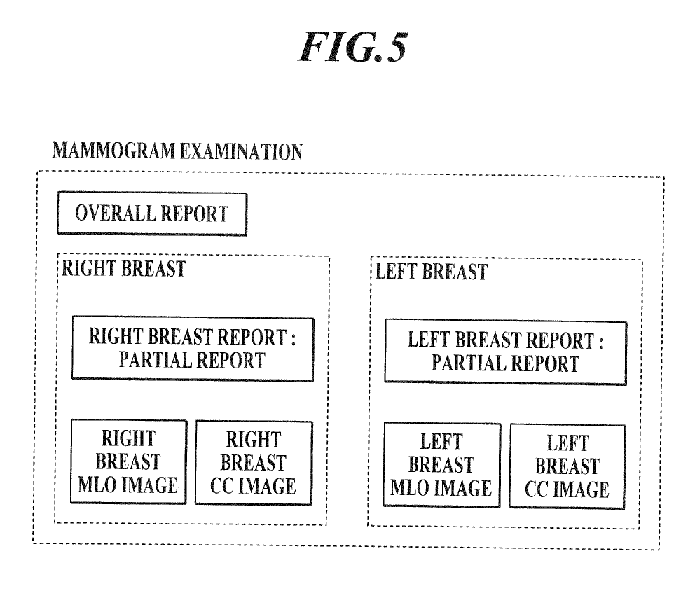

FIG. 5 is an image view showing a relationship between interpretation reports and medical images in a mammogram examination. As shown in FIG. 5, a mammogram examination is constituted of a right breast examination and a left breast examination.

In the right breast examination, a medical image (right breast MLO image) taken from MLO (MedioLateral-Oblique direction) and a medical image (right breast CC image) taken from CC (Cranial-Caudal direction) are generated in the modality 20. Also, an interpretation report on the right breast MLO image and the right breast CC image is generated. The right breast report is a partial report. The partial report is described below.

Similarly, in the left breast examination, a medical image (left breast MLO image) taken from MLO (MedioLateral-Oblique direction) and a medical image (left breast CC image) taken from CC (Cranial-Caudal direction) are generated in the modality 20. Also, an interpretation report on the left breast MLO image and the left breast CC image is generated. The left breast report is a partial report. Thus, a partial report is generated on each side (right and left), namely, on each of the right breast and the left breast of a patient.

In the mammogram examination, an interpretation report (overall report) in which the right breast report and the left breast report are comprehensively assessed is generated.

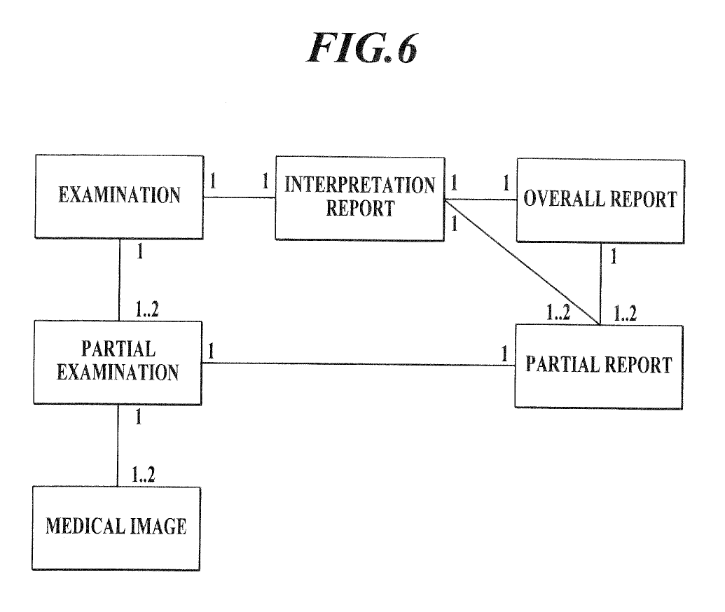

FIG. 6 is a block diagram showing a data model of an interpretation report (interpretation report data) in a mammogram examination. In the report DB 151, examinations, interpretation reports, medical images, and the like are correlated in accordance with this data model. As shown in FIG. 6, in a mammogram examination, an interpretation report is generated for each examination. Interpretation report data for one examination is referred to as an interpretation report data object.

As described above, a mammogram examination includes two partial examinations. More specifically, the two partial examinations are a right breast examination and a left breast examination. In each partial examination, medial image data for two medical images, namely, two medical image data objects, are generated. More specifically, one of the two medical image data objects is data corresponding to the medical image taken from MLO in the modality 20 (the right breast MLO image or the left breast MLO image), and the other thereof is data corresponding to the medical image taken from CC therein (the right breast CC image or the left breast CC image).

In an interpretation report for one examination, two partial reports and one overall report are included. A partial report is an interpretation report for a partial examination. That is, an interpretation report for one examination includes a partial interpretation report for the right breast examination (right breast report) and a partial interpretation report for the left breast examination (left breast report). The overall report is an interpretation report (overall report) in which the partial examinations are comprehensively assessed. That is, an interpretation report for one examination includes an overall interpretation report in which the right breast examination and the left breast examination are comprehensively assessed. Data of a partial report for one partial examination is referred to as a partial report data object, and data of one overall report is referred to as an overall report data object.

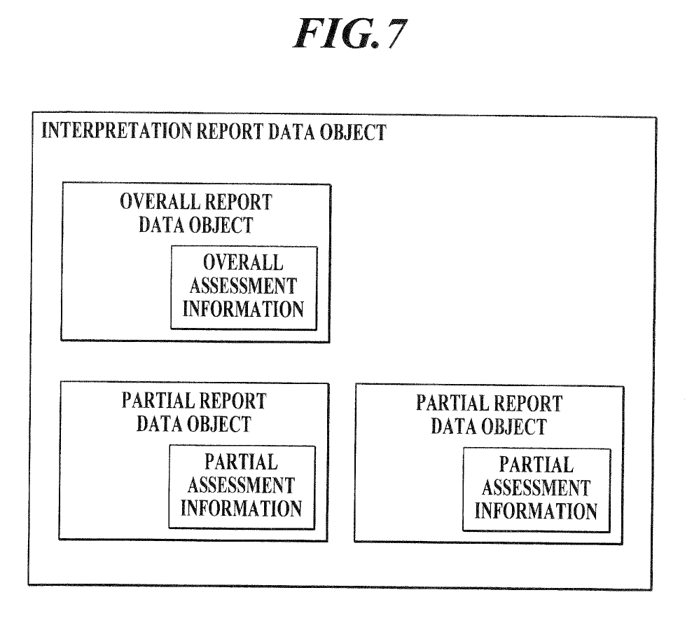

FIG. 7 is a block diagram showing a data configuration of an interpretation report data object stored and managed by the report DB 151. As shown in FIG. 7, an interpretation report data object includes one overall report data object and two partial report data objects. Each of the partial report data objects includes partial assessment information. The overall report data object includes overall assessment information. In the report DB 151, one interpretation report data object or a plurality of interpretation report data objects is stored.

### [Specific Operation of Report Generation Management Device or the Like]

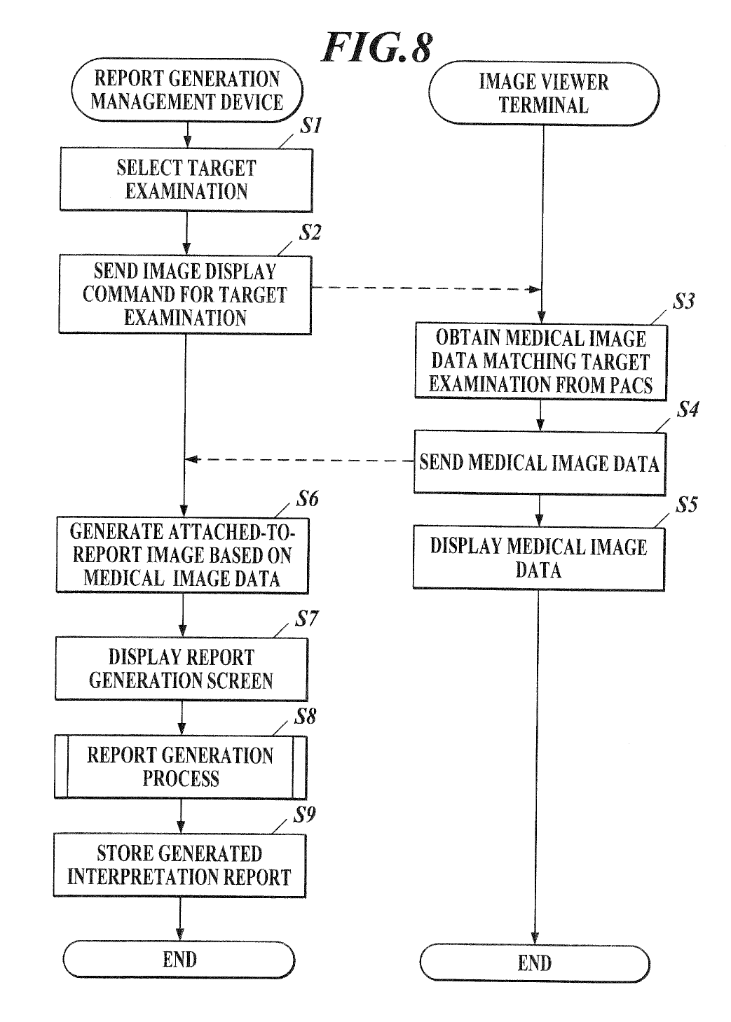

Next, specific operations performed by the report generation management device 10 and the image viewer terminal 30 are described referring to FIG. 8.

A user operates the operation unit 12 of the report generation management device 10 to select an examination for which an interpretation report is generated (interpretation work). Accordingly, the control unit 11 selects a target examination for which an interpretation report is generated, based on an operation signal from the operation unit 12 (Step S1).

Then, the control unit 11 generates an image display command including an examination ID of the examination selected at Step S1, a patient ID of a patient undergoing the examination, and the like. The control unit 11 sends the generated image display command to the image viewer terminal 30 via the communication unit 14 (Step S2).

When receiving (obtaining) the image display command from the report generation management device 10 via the communication unit 34, the control unit 31 of the image viewer terminal 30 obtains medical image data matching the examination, for which an interpretation report is generated, from the PACS 40 (Step S3). More specifically, the control unit 31 uses the patient ID or the examination ID included in the obtained image display command as a search key. The control unit 31 generates a medical image data obtaining request including the search key. The control unit 31 sends the generated medical image data obtaining request to the PACS 40 via the communication unit 34. Then, the control unit 31 receives medical image data corresponding to the obtaining request from the PACS 40 via the communication unit 34. The medical image data corresponding to the obtaining request are four medial image data objects respectively corresponding to a right breast MLO image, a right breast CC image, a left breast MLO image, and a left breast CC image.

The control unit 31 sends the medical image data (four medical image data objects) obtained from the PACS 40 to the report generation management device 10 via the communication unit 34 (Step S4).

Then, the control unit 31 displays the medial image data obtained from the PACS 40 on the display unit 33 (Step S5). More specifically, the control unit 31 displays the right breast MLO image, the right breast CC image, the left breast MLO image, and the left breast CC image, and supplementary information on each of the four images on a high definition monitor. A radiologist performs the interpretation work referring to the images displayed on the high definition monitor.

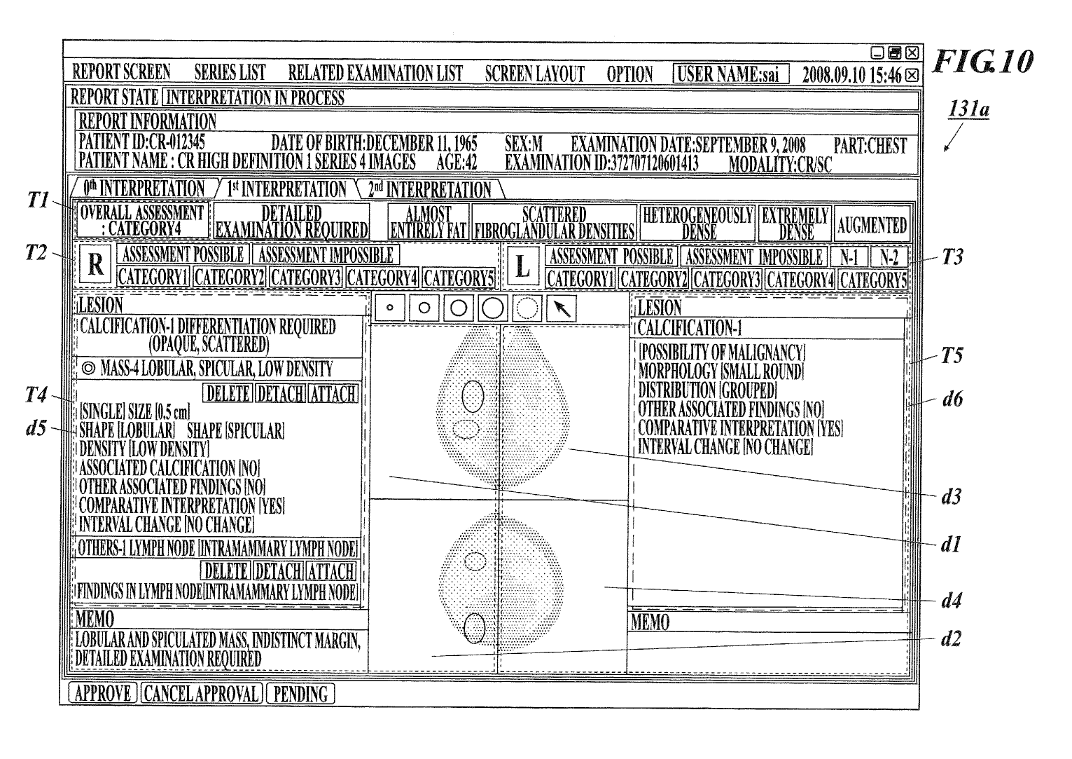

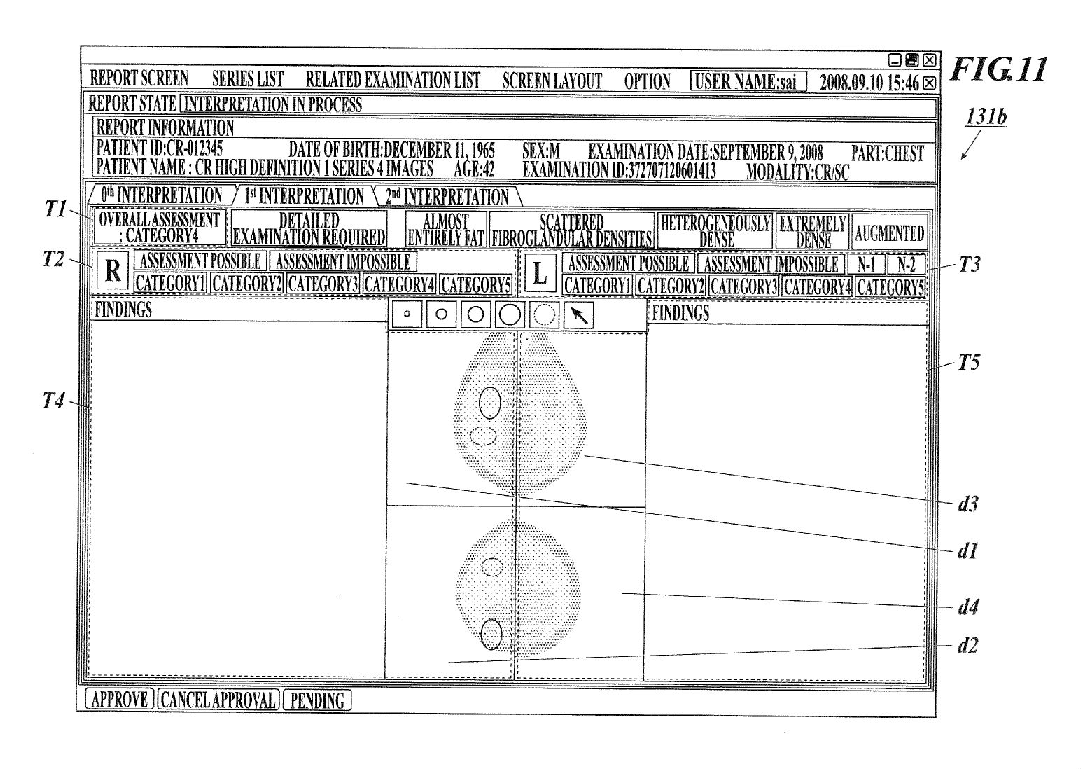

On the other hand, when receiving the medical image data from the image viewer terminal 30 via the communication unit 14, the control unit 11 of the report generation management device 10 generates attached-to-report images (attached-to-report image data) based on the medical image data (Step S6). More specifically, the control unit 11 performs a size change process and the like on the medical image data, the size change process by which the size of the medical image data is changed so that the medical image data can be attached to the interpretation report, thereby generating the attached-to-report image data suitable to be displayed on a report generation screen 131 (shown in FIGS. 10 and 11).

Then, the control unit 11 displays, on the display unit 13, the report generation screen 131 to which the attached-to-report image data is attached (Step S7).

FIGS. 10 and 11 show examples of the report generation screen 131. FIG. 10 shows a report generation screen 131a including lesion report templates d5 and d6. FIG. 11 shows a report generation screen 131b not including the lesion report templates d5 and d6.

As shown in FIG. 10, the report generation screen 131a is constituted of an overall assessment display region T1, a right breast partial assessment setting region T2, a left breast partial assessment setting region T3, a right breast report writing region T4, a left breast report writing region T5, and the like. The right breast report writing region T4 includes attached-to-report images d1 and d2 and the lesion report template d5. The left breast report writing region T5 includes attached-to-report images d3 and d4 and the lesion report template d6.

The attached-to-report image d1 is a right breast MLO image, and the attached-to-report image d2 is a right breast CC image. The attached-to-report image d3 is a left breast MLO image, and the attached-to-report image d4 is a left breast CC image.

The right breast report writing region T4 is a region to write a right breast report. A user writes a partial report in the right breast report writing region T4 via the operation unit 12. In addition, a user can create the partial report following a template in the lesion report template d5.

The right breast partial assessment setting region T2 is a region to make a partial assessment of the right breast report. A user selects buttons from the category buttons 1 to 5 and the like arranged in the right breast partial assessment setting region T2 via the operation unit 12, thereby making the partial assessment of the right breast report. When abnormalities are not found, the category 1 is selected. When there is a finding which can be surely diagnosed as benign, the category 2 is selected. When there is a finding which should be benign but the possibility of being malignant cannot be denied, the category 3 is selected. When there is a finding which is suspected of being malignant, the category 4 is selected. When there is a finding which is malignant, the category 5 is selected. That is, the larger the number of the category becomes (from the category 1 to the category 5), the worse the diagnosis result is.

The left breast report writing region T5 is a region to write a left breast report. A user writes a partial report in the left breast report writing region T5 via the operation unit 12. In addition, a user can create the partial report following a template in the lesion report template d6.

The left breast partial assessment setting region T3 is a region to make a partial assessment of the left breast report. A user selects buttons from category buttons 1 to 5 and the like arranged in the left breast partial assessment setting region T3 via the operation unit 12, thereby making the partial assessment of the left breast report.

The overall assessment display region T1 is a region to display information on an overall report in which the partial examinations are comprehensively assessed.

As shown in FIG. 11, the report generation screen 131b is constituted of an overall assessment display region T1, a right breast partial assessment setting region T2, a left breast partial assessment setting region T3, a right breast report writing region T4, a left breast report writing region T5, and the like. The right breast report writing region T4 includes attached-to-report images d1 and d2. The left breast report writing region T5 includes attached-to-report images d3 and d4.

As shown in FIG. 8, the control unit 11 performs a report generation process (Step S8). The report generation process is a process by which an interpretation report (interpretation report data object) is generated based on an operation signal or the like sent from the operation unit 12, the operation signal which is generated when a user performs an operation on the report generation screen 131. The generated interpretation report data objet is data of the examination selected at Step S1. The report generation process is described below.

The control unit 11 stores (saves) the interpretation report data object in the report DB 151 of the storage unit 15, the interpretation report data object which is generated by the report generation process at Step 8 (Step S9). Thus, the operations end.

### [Report Generation Process]

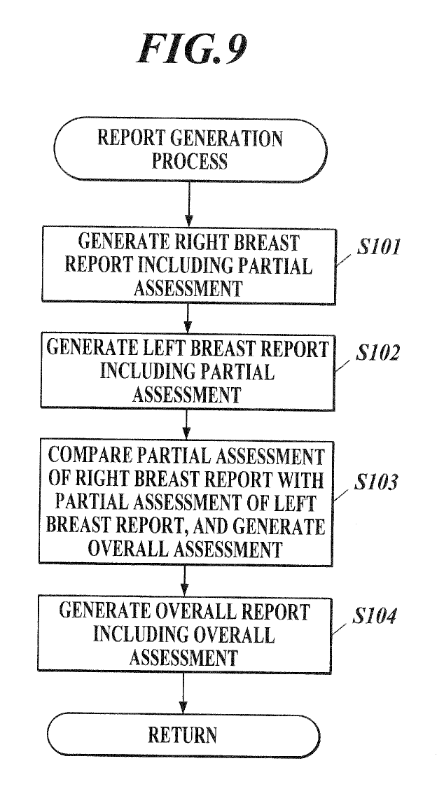

Next, specific process contents of the report generation process (Step S8 shown in FIG. 8) are described referring to FIG. 9.

A user writes a partial report (right breast report) in the right breast report writing region T4 of the report generation screen 131 via the operation unit 12. The user selects one of the categories 1 to 5 in the right breast partial assessment setting region T2 via the operation unit 12.

The control unit 11 of the report generation management device 10 generates the right breast report (partial report data object) including a partial assessment (partial assessment information) based on an operation signal from the operation unit 12 (Step S101). A value of the one of the categories 1 to 5 selected in the right breast partial assessment setting region T2 is set to the partial assessment information. The partial report written in the right breast report writing region T4 is stored in the generated partial report data object as actual data of the partial report.

The user writes a partial report (left breast report) in the left breast report writing region T5 of the report generation screen 131 via the operation unit 12. The user selects one of the categories 1 to 5 in the left breast partial assessment setting region T3 via the operation unit 12.

The control unit 11 of the report generation management device 10 generates the left breast report (partial report data object) including a partial assessment (partial assessment information) based on an operation signal from the operation unit 12 (Step S102). A value of the one of the categories 1 to 5 selected in the left breast partial assessment setting region T3 is set to the partial assessment information. The partial report written in the left breast report writing region T5 is stored in the generated partial report data object as actual data of the partial report.

Next, the control unit 11 compares the partial assessment of the right breast report with the partial assessment of the left breast report, and generates information on an overall assessment (overall assessment information) (Step S103). More specifically, the control unit 11 compares a value (categories 1 to 5) of the partial assessment information included in the right breast partial report data object with a value (categories 1 to 5) of the partial assessment information included in the left breast partial report data object. Then, the control unit 11 determines the higher value (category value) as a value of the overall assessment information. For example, when the right breast partial assessment information is the category 1, and the left breast partial assessment information is the category 4, the control unit 11 determines that the overall assessment information is the category 4.

Then, the control unit 11 generates an overall report (overall report data object) including the overall assessment (overall assessment information) (Step S104). Also, the control unit 11 shows the value of the overall assessment information in the overall assessment display region T2. More specifically, when the overall assessment information is the category 4, the control unit 11 displays “Overall Assessment: Category 4” in the overall assessment display region T2. Then, the report generation process ends.

As described above, according to the embodiment, the control unit 11 of the report generation management device 10 generates an interpretation report data object, and stores the interpretation report data object in the report DB 151 of the storage unit 15 so as to manage the object. An interpretation report data object is interpretation report data for one examination (mammogram examination), and includes a partial report data object corresponding to an interpretation report on a left breast and an partial report data object corresponding to an interpretation report on a right breast. That is, the control unit 11 generates interpretation report data (partial report data objects) on a right breast and a left breast for one examination (mammogram examination), and correlates the two interpretation report data objects with the mammogram examination.

Consequently, when a user such as a radiologist uses the report generation management device 10 in the radiology system 100, the radiology system 100 becomes suitable for a mammogram examination which requires two assessments (interpretation reports) for one examination.

Furthermore, the control unit 11 generates overall assessment information included in a comprehensive interpretation report (overall report data object) for a mammogram examination, referring to partial assessment information included in each of right breast and left breast interpretation reports (partial report data objects).

Consequently, a user such as a radiologist does not need to manually enter the overall assessment information on the report generation screen 131, and hence the convenience can be increased in a case where two assessments (interpretation reports) are required for one examination.

The embodiment is an example of the report generation management device of the present invention. Hence, the present invention is not limited to the embodiment. Also, the detailed configurations and detailed operations of the system and the devices can be appropriately modified.

For example, in the embodiment, the image viewer terminal 30 and the PACS 40 are separate devices. However, the image viewer terminal 30 and the PACS 40 may be integrated into one device. Furthermore, in the embodiment, the report generation management device 10 and the image viewer terminal 30 are separate devices. However, the report generation management device 10 and the image viewer terminal 30 may be integrated into one device.

Furthermore, in the embodiment, as a computer readable medium which stores a program, a hard disk is used. However, this is not a limit. As the computer readable medium, a portable storage medium such as a CD-ROM, a non-volatile memory such as a flush memory, or the like can be used. Furthermore, as a medium which provides data of the program via a communication line, a carrier wave may be used.

### [Modification]

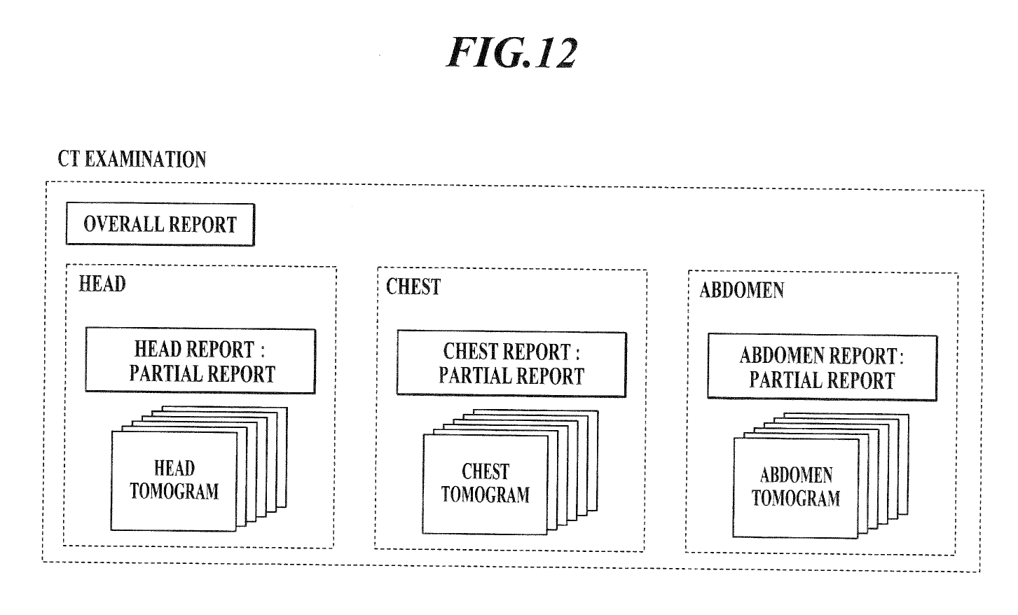

Next, a modification of the embodiment, the modification in which the report generation management device of the present invention is applied to the report generation management device 10 shown in FIG. 1, is described referring to FIGS. 12 to 14. The modification is mainly described from the points different from the embodiment.

The embodiment is described taking the breast photographic device as the modality 20. However, the modification is described taking a CT device as the modality 20. In the following, an examination performed by a CT device is referred to as a CT examination. It is assumed that, in a CT examination, a subject is photographed from the head to the abdomen in one examination.

FIG. 12 is an image view showing a relationship between interpretation reposts and medical images in a CT examination. As shown in FIG. 12, a CT examination is constituted of a head examination, a chest examination, and an abdomen examination. These examinations are internally divided from the CT examination by a radiologist or the like operating the modality 20.

In a CT examination, a plurality of tomograms is generated by the modality 20. Then, by the operation of the radiologist or the like, the tomograms are divided into a head tomogram set for the head examination, a chest tomogram set for the chest examination, and an abdomen tomogram set for the abdomen examination. More specifically, for example, when one thousand tomograms are taken by the modality 20, the user performs an operation onto the modality 20 so that the 1^{st} to the 200^{th} tomograms are head tomograms, the 201^{st} to the 600^{th} tomograms are chest tomograms, and the 601^{st} to the 1000^{th} tomograms are abdomen tomograms. Based on the operation by the user, the modality 20 divides the one thousand tomograms into the head tomogram set, the chest tomogram set, and the abdomen tomogram set. Based on the tomogram sets, the modality 20 internally divides the CT examination into the head examination, the chest examination, and the abdomen examination.

In the head examination, an interpretation report on the head tomogram set (head report) is generated. In the chest examination, an interpretation report on the chest tomogram set (chest report) is generated. In the abdomen examination, an interpretation report on the abdomen tomogram set (abdomen report) is generated. The head report, the chest report, and the abdomen report are partial reports.

In the CT examination, a comprehensive report (overall report) in which the head report, the chest report and the abdomen report are comprehensively assessed is generated.

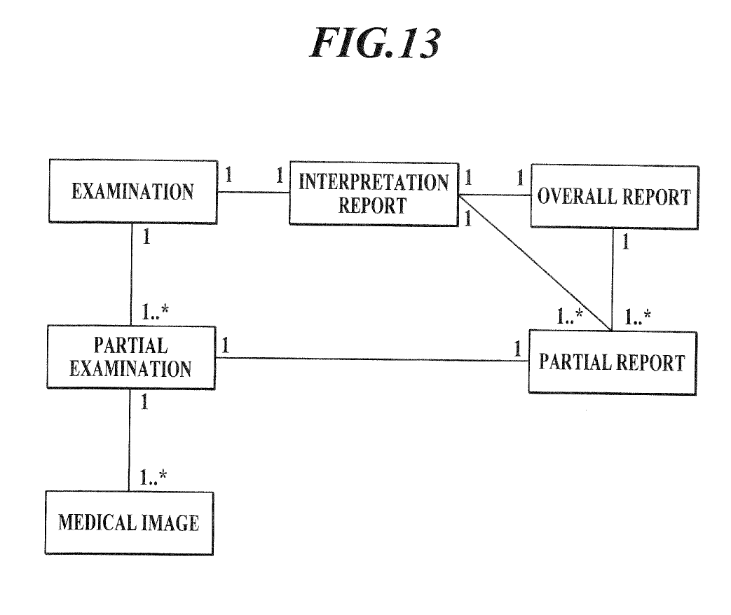

FIG. 13 shows a block diagram showing a data model of an interpretation report (interpretation report data) in a CT examination. In the report DB 151, examinations, interpretation reports, medical images, and the like are correlated in accordance with this data model. As shown in FIG. 13, in the CT examination, an interpretation report is generated for each examination (each CT examination).

A CT examination includes a plurality of partial examinations. In the modification, a CT examination includes three partial examinations of the head examination, the chest examination, and the abdomen examination. However, the number of partial examinations is not limited to three, and may be four, five, or even more. In each partial examination, medical image data for a plurality of medical images, namely, a plurality of medical image data objects, is generated.

An interpretation report for one examination includes a plurality of partial reports and one overall report.

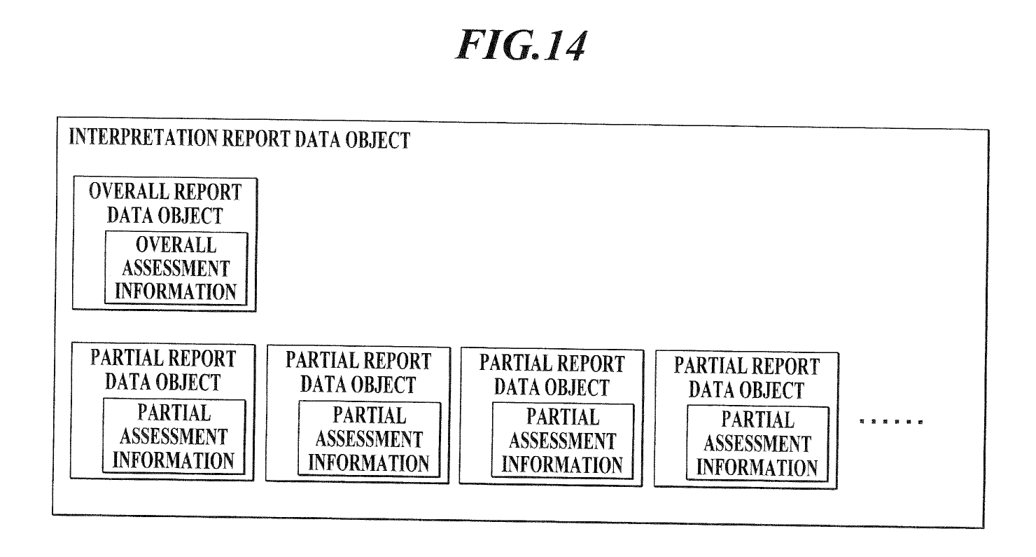

FIG. 14 is a block diagram showing a data configuration of an interpretation report data object stored and managed by the report DB 151. As shown in FIG. 14, an interpretation report data object includes one overall report data object and a plurality of partial report data objects. Each of the partial report data objects includes partial assessment information. The overall report data object includes overall assessment information. In the report DB 151, one interpretation report data object or a plurality of interpretation report data objects is stored.

As described above, according to the modification of the embodiment, the control unit 11 of the report generation management device 10 generates an interpretation report data object, and stores the interpretation report data object in the report DB 151 of the storage unit 15 so as to manage the object. An interpretation report data object is interpretation report data for one examination, and includes a plurality of partial report data objects. That is, the control unit 11 generates a plurality of interpretation report data (partial report data objects) for one examination, and correlates the plurality of interpretation report data objects with the examination.

Consequently, when a user such as a radiologist uses the report generation management device 10 in the radiology system 100, the radiology system 100 becomes suitable for the examination which requires a plurality of assessments (interpretation reports) for one examination.

Furthermore, the control unit 11 generates overall assessment information included in a comprehensive interpretation report (overall report data object) for the examination, referring to the partial assessment information included in each of the interpretation reports (partial report data objects).

Consequently, a user such as a radiologist does not need to manually enter the overall assessment information on the report generation screen 131, and hence the convenience can be increased in a case where two assessments (interpretation reports) are required for one examination.

In the modification, the control unit 11 of the report generation management device 10 generates a partial report on medical images of each part of a subject. However, the control unit 11 may generate a partial report on each series of medical images.

More specifically, the control unit 11 refers to series information included in supplementary information in medical image data obtained from the PACS 40 via the communication unit 14, divides the medical image data objects into a plurality of series of medical images, and generates a partial report data object on each series of medical image.

### INDUSTRIAL APPLICABILITY

The present invention can be used in the field of medical services, and can be applied to a report generation management device in a radiology system.

### EXPLANATION OF REFERENCES

10 report generation management device
11 control unit
12 operation unit
13 display unit
14 communication unit
15 storage unit
16 bus
20 modality
30 image viewer terminal
31 control unit
32 operation unit
33 display unit
34 communication unit
33 storage unit
36 bus
40 PACS
100 radiology system
131 report generation screen
N network
T1 overall assessment display region
T2 right breast partial assessment setting region
T3 left breast partial assessment setting region
T4 right breast report writing region
T5 left breast report writing region

1. A report generation management device comprising:
a storage unit which stores interpretation report information; and
a control unit which generates a plurality of pieces of the interpretation report information for one examination, stores the generated pieces of the interpretation report information in the storage unit, and manages the generated pieces of the interpretation report information by correlating the generated pieces of the interpretation report information with the examination.

2. The report generation management device according to claim 1, wherein the control unit generates each of the pieces of the interpretation report information on a medical image of a part of a subject in the examination.

3. The report generation management device according to claim 1, wherein the control unit generates each of the pieces of the interpretation report information on a medical image of a side of a subject in the examination.

4. The report generation management device according to claim 3, wherein the examination is a mammogram examination, and the medical image of the side of the subject is a right breast image or a left breast image.

5. The report generation management device according to claim 1, wherein the control unit generates each of the pieces of the interpretation report information on a series of a medical image in the examination.

6. The report generation management device according to claim 1, wherein the control unit generates overall interpretation report information for the examination based on the pieces of the interpretation report information.

7. A non-transitory computer-readable storage medium having a program stored thereon for controlling a computer of to function as units comprising:
a storage unit which stores interpretation report information; and
a control unit which generates a plurality of pieces of the interpretation report information for one examination, stores the generated pieces of the interpretation report information in the storage unit, and manages the generated pieces of the interpretation report information by correlating the generated pieces of the interpretation report information with the examination.
